(19) United States
(12) Patent Application Publication
(10) Pub. No.: US 2016/0142798 A1
(43) Pub. Date: May 19, 2016

(54) TRANSMISSION APPARATUS

(71) Applicant: FUJITSU LIMITED, Kawasaki-shi (JP)

(72) Inventors: HIDETAKA KAWAHARA, Shimotsuga (JP); Hiromichi Makishima, Oyama (JP); Hiroyuki Kitajima, Oyama (JP); Yuji OBANA, Mibu (JP); Shingo HOTTA, Yokohama (JP); Wataru Odashima, Oyama (JP)

(73) Assignee: FUJITSU LIMITED, Kawasaki-shi (JP)

(21) Appl. No.: 14/919,089

(22) Filed: Oct. 21, 2015

(30) Foreign Application Priority Data
Nov. 19, 2014 (JP) 2014-234402

(51) Int. Cl. H04Q 11/00; H04J 3/16

(52) U.S. Cl. CPC H04Q 11/0066; H04J 3/1652; H04Q 11/0003; H04Q 2011/0064

(57) ABSTRACT

A transmission apparatus includes: a reception processing unit configured to perform a reception processing on a first signal into which second signals having different rates and including overhead information are hierarchically multiplexed; and a common overhead processing unit configured to process the overhead information included in the first and second signals according to a common rate to hierarchical layers.

### CROSS-REFERENCE TO RELATED APPLICATION

This application is based upon and claims the benefit of priority from the prior Japanese Patent Application No. 2014-234402, filed on Nov. 19, 2014, the entire contents of which are incorporated herein by reference.

### FIELD

The embodiments discussed herein are related to a transmission apparatus.

### BACKGROUND

There has been an OTN (Optical Transport Network) transmission technology as an example of an optical transmission technology. In the OTN transmission technology, a plurality of low speed signals referred to as, for example, LO-ODU signals are multiplexed (may also be referred to as “mapping”) into high-speed signals referred to as HO-ODU signals (or, OTN signal) to be transmitted.

At a receiving side of the HO-ODU signals, the plurality of LO-ODU signals multiplexed into the received HO-ODU signals are demultiplexed (may also be referred to as “demapped”). The “LO-ODU” is an abbreviation of “Low Order-Optical Data Unit” and the “HO-ODU” is an abbreviation of “High Order-Optical Data Unit.”

The HO-ODU signals may be referred to as “high speed signals,” “higher-order signals,” or “higher layer signals,” and the LO-ODU signals may be referred to as “low speed signals,” “lower-order signals,” or “lower layer signals.”

A related technology is disclosed in, for example, International Publication Pamphlet No. WO 2008/035769.

### SUMMARY

According to an aspect of the invention, a transmission apparatus includes: a reception processing unit configured to perform a reception processing on a first signal into which second signals having different rates and including overhead information are hierarchically multiplexed; and a common overhead processing unit configured to process the overhead information included in the first and second signals according to a common rate to hierarchical layers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a communication system according to an embodiment of the present disclosure;

FIG. 2 is a block diagram illustrating an exemplary configuration of an ADM (Add-Drop Multiplexer) illustrated in FIG. 1;

FIG. 3 is a block diagram illustrating another exemplary configuration of the ADM illustrated in FIG. 1;

FIG. 4 is a block diagram illustrating another exemplary configuration of the ADM illustrated in FIG. 1;

FIG. 5 is a diagram illustrating an example of a connection between an overhead (OH) processing unit and an H/S interface illustrated in FIG. 2 to FIG. 4;

FIG. 6 is a block diagram illustrating another exemplary configuration of the ADM illustrated in FIG. 1;

FIG. 7 is a block diagram illustrating an exemplary configuration of a common OH processing unit illustrated in FIG. 6;

FIG. 8 is a block diagram illustrating an example of input/output port connections of an OH processing scheduler illustrated in FIG. 7;

FIG. 9 is a timing chart for explaining an example of operations of the OH processing scheduler illustrated in FIG. 7 and FIG. 8;

FIG. 10 is a flowchart for explaining the example of operations of the OH processing scheduler illustrated in FIG. 7 and FIG. 8;

FIG. 11 is a block diagram illustrating an example of a connection between the OH processing circuit and the common H/S interface illustrated in FIG. 7;

FIG. 12 is a flowchart for explaining an example of operations of the OH processing circuit and the common H/S interface illustrated in FIG. 11; and

FIG. 13 is a flowchart for explaining another example of operations of the OH processing circuit and the common H/S interface illustrated in FIG. 11.

### DESCRIPTION OF EMBODIMENTS

There has been an overhead (OH) information processing (e.g., termination, monitoring, change) as an example of a reception processing of the OTN signal. Various types of signals having various rates may be hierarchically mapped into the OTN signals and the OH information is added to each of the signals.

Therefore, for example, when the capacity of the OTN signals increases and the types (may be referred to as a “layer”) of signals capable of being mapped into the OTN signals increases, the amount of the target OH information to be processed also increases. The target OH information to be processed also increases, for example, as the number of OTN signals increases due to, for example, the increase of the number of input ports of the OTN signals in a transmission without being limited to the increase of the capacity of the OTN signal itself.

When the OH processing is individually and separately conducted for each port and each layer, the consumption of hardware resources for the OH processing increases. Therefore, the hardware scale for implementing the OH processing may be increased and the power consumption may also be increased.

Descriptions will be made on an embodiment of a transmission apparatus capable of reducing the hardware scale for implementing the overhead processing with reference to accompanying drawings. In the meantime, the embodiment to be described in the following is illustrative only and it is not intended to exclude adaptation of various modifications and technologies not explicitly described in the following. Further, various illustrative aspects described in the following may be appropriately combined to be embodied. Portions denoted by same reference numerals in the drawings referenced in the following embodiment indicate similar or the same portions unless otherwise explicitly states.

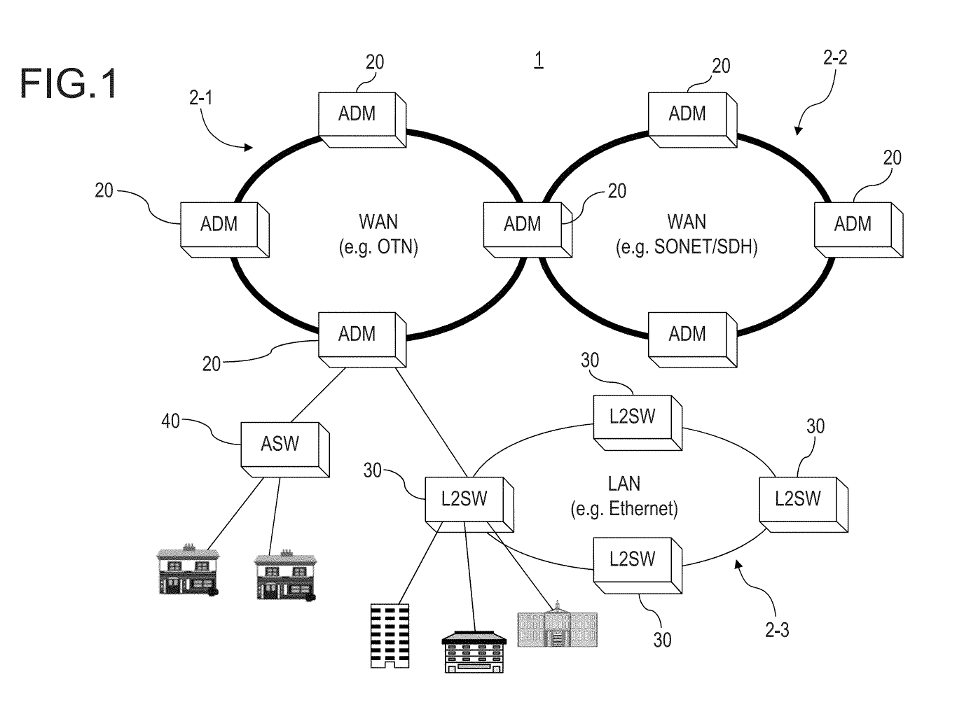

FIG. 1 is a diagram illustrating an exemplary configuration of a communication system according to an embodiment of the present disclosure. A communication system 1 illustrated in FIG. 1 is illustratively provided with a network 2-1 that supports the transmission over the OTN, a network 2-2 that supports the transmission over SONET (or SDH), and an Ethernet 2-3 that supports the transmission of Ethernet frames. The communication system may be referred to as a communication network.

The network 2-1 is also referred to as an OTN 2-1 and the network 2-2 is also referred to as a SONET/SDH network 2-2. As illustrated in FIG. 1, any one of the networks 2-1 and 2-2 may be the WAN (Wide Area Network), and the Ethernet 2-3 may be the LAN (Local Area Network).

The “OTN” is an abbreviation of “Optical Transport Network,” the “SONET” is an abbreviation of “Synchronous Optical Network,” and the “SDH” is an abbreviation of “Synchronous Digital Hierarchy.” The “SONET” and the “SDH” are transmission schemes compatible with each other. The “Ethernet” is a registered trademark.

The networks 2-1 and 2-2 may be provided with a single or a plurality of ADMs 20 as an example of a network element (NE). The ADM 20 which is an example of the NE may be referred to as, for example, a “transmission apparatus,” a “node,” and a “station.” Further, the network 2-3 may be provided with a single or a plurality of layer 2 switches (L2SWs) 30 as an example of the NE. The L2SW may be referred to as a “router.”

In the example of FIG. 1, the NEs are connected with each other in the networks 2-1 to 2-3 through transmission paths to form the ring networks 2-1, 2-2, and 2-3. However, the shape (may be referred to as “topology”) of the networks 2-1 to 2-3 is not limited to the ring network. For example, any one side of the networks 2-1 to 2-3 may be a mesh network.

As illustrated in FIG. 1, the networks 2-1 and 2-2 may be connected to be communicable with each other through any one side of the ADMs 20. Further, the OTN 2-1 and the Ethernet 2-3 may be connected to be communicable with each other through the other one side of the ADMs 20 in the OTN 2-1. For example, the ADM 20 of the OTN 2-1 and the L2SW 30 of the Ethernet 2-3 may be connected to be communicable with each other.

Both of the ADM 20 connecting the networks 2-1 and 2-2 and the ADM 20 connecting the networks 2-1 and 2-3 may be referred to as “gateway (GW) nodes” or simply “gateway (GW).” Accordingly, the ADM 20 functioning as the GW may be denoted as a “GW-ADM 20” for convenience.

As for the GW-ADM 20 connecting the networks 2-1 and 2-3, the GW-ADM 20 may multiplex (“mapping”) a plurality of signals received from the Ethernet 2-3 (L2SW 30) into the signal of the OTN 2-1 with a multiplicity.

The signal received from the Ethernet 2-3 may be the LO-ODU signal. The Ethernet signal is mapped into the payload of the LO-ODU signal. The LO-ODU signal is mapped into the payload of the HO-ODU signal which is a higher speed signal than the LO-ODU signal. The HO-ODU signal is mapped into the payload of the OTN signal and transmitted to the OTN 2-1. The HO-ODU signal is an example of the first signal and the LO-ODU signal is an example of the second signal.

The payload of the HO-ODU signal may be divided into “Tributary Slots (TSs)” and the LO-ODU signal is allowed to be mapped into the HO-ODU signal in unit of TS.

The “Tributary” may be regarded as corresponding to a transmission destination of the LO-ODU signal demapped from the HO-ODU signal (in other words, a transmission source of the LO-ODU signal mapped into the HO-ODU signal). For example, the Ethernet 2-3 may be regarded as corresponding to a “tributary network” of the OTN 1. The “OTN 1” may be regarded as corresponding to a “core network” with respect to the “tributary network.”

The “tributary network” may be referred to as a “client network” and a signal transmitted on the “client network” may be referred to as the “client signal.” Therefore, the “LO-ODU signal” mapped into the TS of the HO-ODU signal may be referred to as either the “client signal” or a “tributary signal.”

In the meantime, the signal transmitted on the core network such as, for example, the HO-ODU signal (OTU signal) into which the LO-ODU signal is mapped may be referred to as a “network signal.” The “OTU” is an abbreviation of “Optical channel Transport Unit.” However, the OTU signal may be regarded as corresponding to the “client signal.”

The network capable of being regarded as corresponding to the tributary network of the OTN 1 is not limited to the Ethernet 2-3. The SONET/SDH network 2-2 may be regarded as corresponding to the “tributary network.” Further, for example, as illustrated in FIG. 1, an aggregate switch (ASW) 40 that gathers (may be referred to as “aggregates”) a plurality of communication routes (may be referred to as “paths” or “channels”) may be connected to be communicable to the ADM 20 of the OTN 1. In this case, the communication routes aggregated by the AGW 40 may be regarded as corresponding to the “tributary network.”

In the meantime, the GW-ADM 20 is able to demap the LO-ODU signal mapped into the payload (HO-ODU signal) of the OTN signal to be transmitted to the Ethernet 2-3 (L2SW).

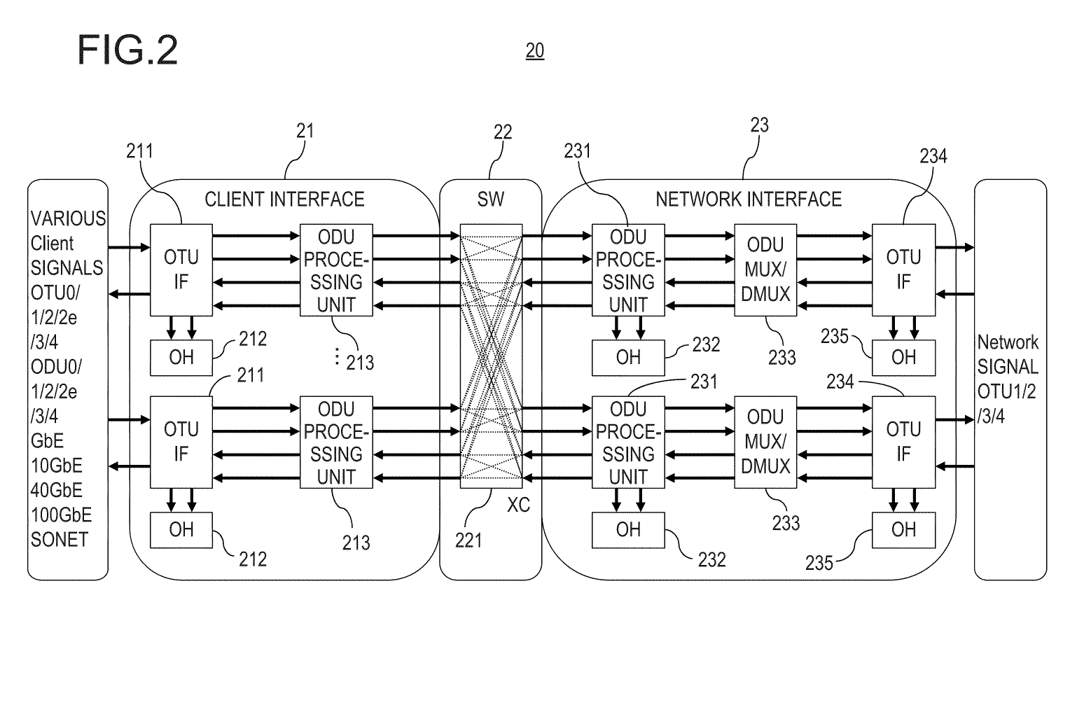

FIG. 2 illustrates an exemplary configuration of the GW-ADM 20. The GW-ADM 20 illustrated in FIG. 2 illustratively includes a client interface 21, a switch (SW) 22, and a network interface 23.

The client interface 21 illustratively supports a signal processing for a plurality types of client signals. Non-limiting examples of the client signal may include an OTUk (Optical channel Transport Unit k) signal, an ODUk (Optical channel Data Unit k) signal, an Ethernet signal, an OC signal over SONET, and an STM signal over the SDH. The “OC” is an abbreviation of “Optical Carrier” and the “STM” is an abbreviation of “Synchronous Transport Module.”

The client interface 21 processes the OTUk signal transmitted to and received from the tributary network.

The ODU signals are mapped into the OTUk signal. When other ODU signals are mapped into the corresponding ODU signal mapped into the OTUk signal, the former ODU signals, that is, the “other ODU signals” are referred to as the “LO-ODU signal,” while the latter ODU signal to which the other ODU signals are mapped is referred to as the “HO-ODU signal.”

The alphabet “k” of the OTUk signal (or ODUk signal) may be a different value (may be referred to as “order”) according to the capacity of corresponding signal (or, a bit rate (transmission speed)). For example, the “k” may include such as, for example, 0, 1, 2, 3, 4, i.e., k=0, 1, 2, 3, 4, etc. The value of “k” may be regarded as indicating a “layer.”

OTU0 signal (or ODU0) assigned with k=0 has a capacity of approximately 1.0 Gbps and may be used in the transmission of, for example, 1 Gbps Ethernet signal.

OTU1 signal (or ODU1) assigned with k=1 has a capacity of approximately 2.4 Gbps and may be used in the transmission of OC-48 (STM-16 of SDH) of SONET.

OTU2 signal (or ODU2) assigned with k=2 has a capacity of approximately 10 Gbps and may be used in the transmission of OC-192 (STM-64) or 10 Gbps Ethernet signal.

OTU3 signal (or ODU3) assigned with k=3 has a capacity of approximately 40 Gbps and may be used in the transmission of OC-768 (STM-256) or 40 Gbps Ethernet signal.

The OTU4 signal (or ODU4) assigned with k=4 has a capacity of approximately 100 Gbps and may be used in the transmission of, for example, 100 Gbps Ethernet signal.

There exists also OTU2e signal having a capacity corresponding to an extension of the capacity of the OTU2 signal or OTU2e signal having a capacity corresponding to an extension of the capacity of the OTU3 signal.

When the value of “k” does not need to be differentiated for the OTUk signal, the OTUk signal may be denoted as “OTN signal” by omitting the alphabet “k.” Also, when the value of “k” does not need to be differentiated for the ODUk signal, the ODUk signal may be denoted as “ODN signal” by omitting the alphabet “k.”

As described above, the OTU signal is created in such a way that client signals of various protocols (may be referred to as “layers”) are hierarchically mapped (may be referred to as “encapsulated”) into the higher speed signal.

Accordingly, various client signals may be transparently transmitted between the networks using the OTU signal without being conscious of a difference in the protocol or a difference in the rate of the client signal.

Therefore, the client interface 21 illustrated in FIG. 2 is provided with N (N is an integer of 1 or more) OTU interfaces (IF) 211, N overhead (OH) processing units 212, and N ODU processing units 213.

The OTU interface 211 processes the OTU signal received from the client network. Further, the OTN interface 211 creates the OTU signal to be transmitted to the client network.

As for the reception sequence from the client network, the OTU interface 211 performs a frame synchronization on, for example, the OTU signal received from the client network to terminate the OH and transmit the OH information to the OH processing unit 212. Further, the “OH information” may be referred to as an “OH data” or an “OH byte” and otherwise, simply as an “OH.”

In the meantime, the OTU interface 211 terminates an FEC (Forward Error Correction) code added in the received OTU signal to be converted into the ODU signal and transmits the ODU signal to the ODU processing unit 213.

In a case where the ODU signal is the HO-ODU signal, since a single or a plurality of LO-ODU signals are multiplexed into the payload, the LO-ODU signals are demultiplexed in the ODU processing unit 213.

In the meantime, as for the transmission sequence to the client network, the OTU interface 211 maps the ODU signal received from the ODU processing unit 213 into the OTU signal and adds the OH to the OTU signal to be transmitted to the client network.

The OH processing unit 212 illustratively performs the OH processing such as creation or monitoring of the OH for the OTU signal.

The ODU processing unit 213 processes the ODU signal received from the OTU interface 211. Further, the ODU processing unit 213 processes the ODU signal received from the switch 22. The ODU signal processing may illustratively include a frame processing to the ODU signals or multiplexing/demultiplexing of the ODU signals.

For example, as for the reception sequence from the client network, the ODU processing unit 213 may demultiplex (demap) the LO-ODU signals multiplexed (mapped) into the HO-ODU signal. Further, when attention is paid to the transmission sequence to the core network, the ODU processing unit 213 may multiplex (map) a single or a plurality of LO-ODU signals into the HO-ODU signal.

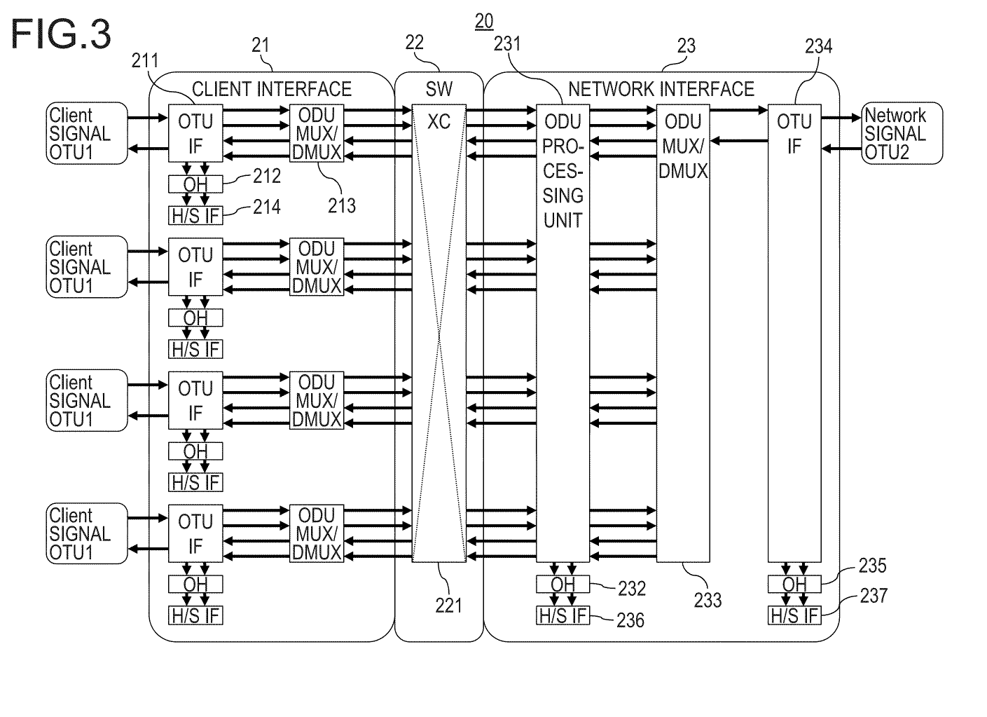

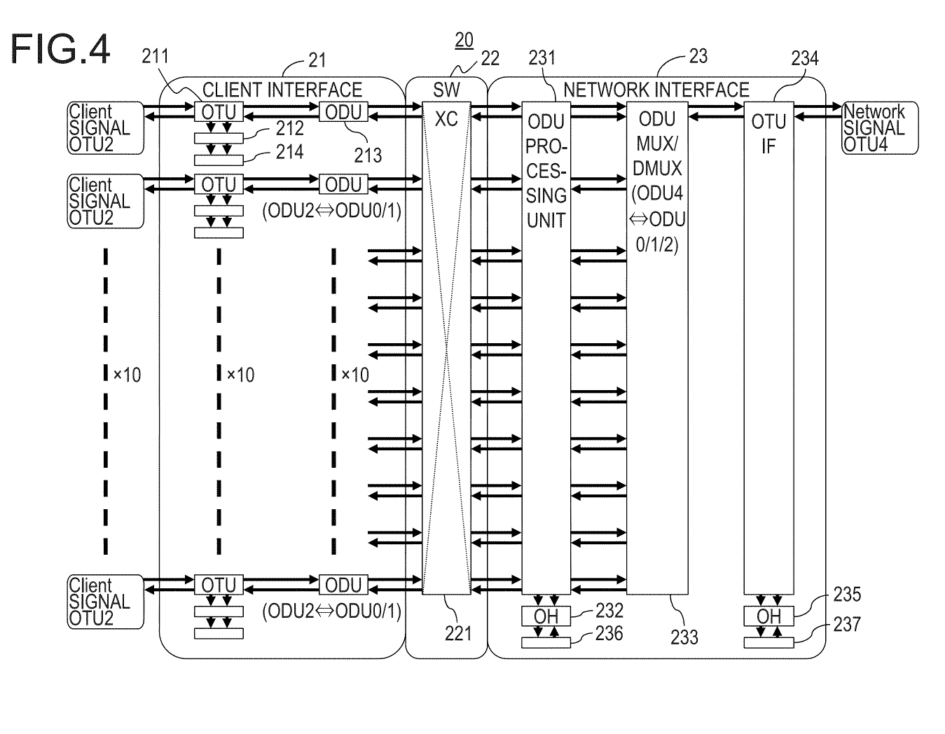

Illustratively, the ODU1 signal may be multiplexed into OTU1 signal (see, e.g., FIG. 3) with multiplicity 1 (one) or the ODU0 signal may be multiplexed into the OTU1 signal with multiplicity 2 (two) at the maximum. Illustratively, the ODU1 signal may be multiplexed into the OTU2 signal (see, e.g., FIG. 4) with multiplicity 4 (four) or the ODU0 signal may be multiplexed into the OTU2 signal with multiplicity 8 (eight) at the maximum.

The switch 22 illustratively cross-connects (XC) the signal transmitted and received between the client interface 21 and the network interface 23 in unit of the LO-ODU signal.

Therefore, the switch 22 illustratively includes a cross connect (XC) switch 221. The XC switch 221 may be implemented by using, for example, a plurality of selectors.

The network interface 23 processes the OTUk signal transmitted to and received from the core network.

Therefore, the network interface 23 illustratively includes N ODU processing units 231, N OH processing units 232, N ODU multiplexers/demultiplexers (ODU MUXs/DMUXs) 233, N OTU interfaces (IF) 234, and N OH processing units 235.

The ODU processing unit 231 illustratively processes the ODU signal received from the XC switch 221 and the ODU signal to be transmitted to the XC switch 221.

The ODU signal processing may include a processing of adding the OH created in the OH processing unit 232 to, for example, the ODU signal received from the XC switch 221 and intended to be transmitted to the core network. Further, the corresponding ODU signal processing may include a processing of terminating the OH of the ODU signal received from the ODU MUX/DMUX 233 and intended to be transmitted to the client network to transmit the OH information to the OH processing unit 232.

The OH processing unit 232 performs the OH processing such as the creation or the monitoring of the OH for the ODU signal.

As for the transmission sequence to the core network, the ODU MUX/DMUX 233 multiplexes the ODU signal processed in the ODU processing unit 231 by the number of ODU signal according to the capacity of the OTU signal destined to the core network and transmits the ODU signal to the OTU interface 234. Further, as for the reception sequence from the core network, the ODU MUX/DMUX 233 demultiplexes the ODU signals mapped into the OTN signal which is received from the OTU interface 234 and transmits the ODU signals to the ODU processing unit 231.

Illustratively, the ODU1 signal may be multiplexed into the OTU2 signal (see, e.g., FIG. 3) with multiplicity 4 (four) at the maximum or the ODU0 signal may be multiplexed into the OTU2 signal with multiplicity 8 (eight) at the maximum. Illustratively, the ODU2 signal may be multiplexed into the OTU4 signal (see, e.g., FIG. 4) with multiplicity 10 (ten), the ODU1 signal may be multiplexed into the OTU4 signal with multiplicity 40 (forty) at the maximum or the ODU0 signal may be multiplexed into the OTU4 signal with multiplicity 80 (eighty) at the maximum.

As for the transmission sequence to the core network, the OTN interface 234 maps the multiplexed ODU signal received from the ODU MUX/DMUX 233 into the OTU signal and transmits the mapped OTU signal to the core network by adding the OH created in the OH processing unit 235 to the mapped OTU signal.

In the meantime, as for the reception sequence from the core network, the OTN interface 234 performs the frame synchronization on the OTN signal received from the core network and terminates the OH to transmit the OH information to the OH processing unit 235. Further, the OTU interface 234 terminates the FEC code added in the received OTU signal to be converted into the ODU signal and transmits the ODU signal to the ODU MUX/DMUX 233.

In the meantime, the OH processing (e.g., monitoring of the OH) described above is performed according to the respective signals when the ports and layers for signals to be processed are different from each other. Therefore, the OH processing units 212, 232, and 235 are provided at different locations in the example of FIG. 2.

FIG. 3 illustrates a more specific example. FIG. 3 illustrates an example in which four input ports of the OTU1 signal which is the client signal and one output port of the OTU2 signal destined to the core network are provided in the ADM 20.

In this case, a number of the OH processing units 212 amounting the number of the OTU1 signal×4 ports, the OH processing unit 232 for the ODU signal, and the OH processing unit 235 for the OTU signal are provided in the ADM 20. In FIG. 3, the reference numerals 214, 236, and 237 indicate hard/soft (H/S) interfaces installed to be corresponded to the OH processing unit 211, 232, and 235, respectively.

The H/S interfaces 214, 236, and 237 interface signals transmitted and received between the OH processing unit 212, 232, and 235 illustratively associated with the H/S interface 214, 236, and 237 and device control units not illustrated in FIG. 3, respectively. Various signals such as setting, request, and notification may be included in the signals.

Various signals described above may be referred to as the “control signal.” The communications made by the “control signal” may be referred to as a “control communication” or a “control access.” Wirings lines used for “the control communication” or the “control access” are arranged between the respective H/S interfaces 214, 236, and 237 and the device control units.

The device control unit may be configured by using a processor device illustratively equipped with an operation processing capability such as, for example, a CPU (Central Processing Unit) or a DSP (Digital Signal Processor) and comprehensively controls the entire operations of the ADM 20.

The processor device may suitably read, for example, a program (may be referred to as “software”) stored in the memory or data and operates such that the relevant control is implemented. The control communication described above may be included in a control implemented by software.

Further, in the following, the “OH processing unit” and the “H/S interface” may be referred to as an “OH circuit” for convenience as an example of a circuit in relation to the OH processing.

As illustrated in FIG. 3, when the ADM has a configuration in which the OH circuit is provided per unit of port or layer, the OH circuit may be replicated so as to easily cope with the addition of the port or the layer. In the meantime, a device scale or power consumption of the ADM 20 may be increased in proportional to the addition of the port or the layer.

For example, as illustrated in FIG. 4, a case is assumed where 10 (ten) input (reception) ports of the OTU2 signal which is an example of the client signal and 1 (one) output port of OTU4 signal which is an example of the network signal are provided in the ADM 20.

In this case, since the ODU0 signals may be multiplexed into the OTU2 signal with multiplicity 8 (eight) at the maximum, the OH circuit are installed at 91 locations, that is, (OTU2×10 ports)+(ODU0×10 ports×multiplicity 8)+(OTU4×1 port)=91 (locations).

When the number of ports or the signal capacity of the layer intended to be supported by the ADM 20 is further increased, the number of the OH circuit is further increased. In such a case, the device scale or power consumption of the ADM 20 is increased to an impermissible extent and a significant influence is exerted on, for example, the design of the ADM 20.

Accordingly, in the present embodiment, an architecture may be implemented in the ADM 20 in which standardization of the OH circuits (may be referred to as “standardization of circuits”) is allowed for ports or layers and the OH processing that does not depend on the number of ports or layers is allowed. Accordingly, the device scale or the power consumption of the ADM 20 is reduced.

However, when standardization of the OH processing is simply allowed and the OH processing for the signals of the ports or the layers is performed on a first-come-first-served basis, the OH processing may not be ended within a predetermined period of time. The predetermined time may be set to a value which amounts to 1 frame time of the OTU signal destined to the core network to which a plurality of ODU signals are mapped.

For example, since the OH processing (e.g., OH monitoring) of the OTU signal may be performed periodically once per 1 frame of the OTU signals, even though the OTU signals are input to a plurality of ports, when the OTU signals are input with the same rate, the OH processing for the OTU signal may be performed on a first-come-first-served basis.

However, in a case where the OH processing is performed on the signals of different layers, since the OH processing of lower layer signals are not ended within 1 frame time of a higher layer signal when the OH processing is simply performed on a first-come-first-served basis, the OH processing for the higher layer signal may not be performed and the OH processing may not become complicated.

For example, as illustrated in FIG. 4, a case is assumed in which the ODU0 signals mapped into each of the number of OTU2 signals amounting to the number of 10 ports with multiplicity 8 (eight) at the maximum (ODU0×10×8) are mapped into the OTU4 signal to be transmitted.

In this case, when the OH processing for 80 ODU0 signals of the lower layer is preferentially performed over the OTU4 signal of the higher layer on a first-come-first-served basis, the OH processing of the ODU0 signals may not be ended within 1 frame time of the OTU4 signal.

For example, it is assumed that an operation clock (may be referred to as “system clock”) of the OH processing is 164 MHz (≈6.1 ns) and 1 frame time (period) of OTU 4 (or ODU 4) signal is 1.168 μs.

Here, when it is assumed that the time taken for the OH processing is 3 clocks or more, the required time taken for the processing is equal to or more than 80×3 (clocks)×6.1 (ns)≈1.46 μs. Therefore, when the OH processing for 80 ODU0 signals is preferentially performed over the OH processing for OTU4 signal, the OH processing for the ODU signals is not ended within 1 frame time of OTU4 signal, which is 1.168 μs. In other words, a frame period of the next OTU4 signal arrives in a state where the OH processing of the ODU signal is not completed.

A one frame period of each layer signal and a layer are exemplified in the following Table 1 for reference.

TABLE 1
Example of frame period of signal of layer

| layer | 1 frame period (μs) |
|---|---|
| OTU4 (ODU4) | 1.168 |
| OTU3 (ODU3) | 3.305 |
| OTU2 (ODU2) | 12.191 |
| OTU1 (ODU1) | 48.971 |
| OTU0 (ODU0) | 98.354 |

Accordingly, in the present embodiment, the OH processing for each port and each layer is scheduled according to a certain priority (may be referred to as a “priority level”). A circuit or portion performing the scheduling in the ADM 20 may be referred to as an “OH processing scheduler.” The priority may illustratively be determined by the layer (in other words, rate) of the signal. Details will be described later.

Further, standardization of the H/S interfaces described above may also be allowed according to the standardization of the OH processing. However, when the standardization of the H/S interfaces is simply allowed, the control signals may be concentrated on the H/S interfaces in a state of being standardized (may be referred to as a “common H/S interface”) and the congestion of the control signals may occur.

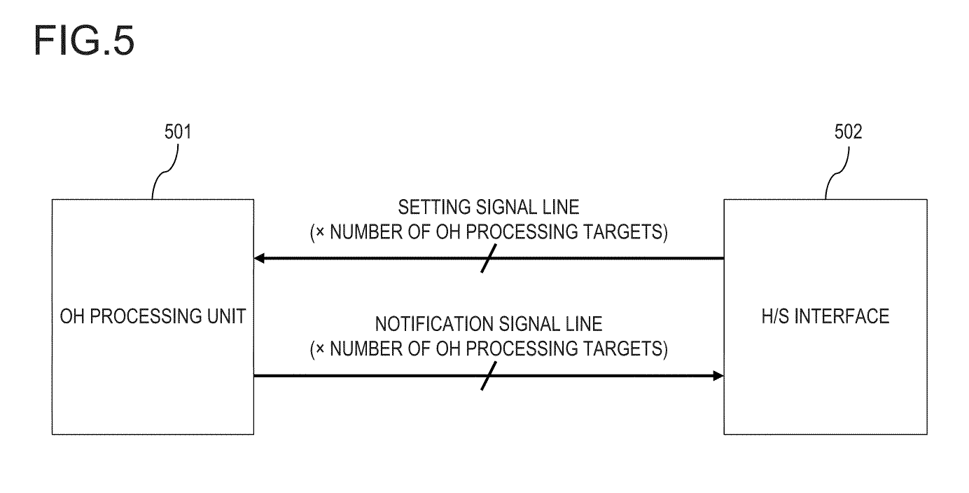

In FIG. 5, an example of a connection of control signals between the OH processing unit and the H/S interface in the configuration illustrated in FIG. 4 is illustrated. As illustrated in FIG. 5, an OH processing unit 501 and an H/S interface 502 are connected with each other by a number of setting signal lines and notification signal lines according to the number of ports and layers.

The OH processing unit 501 of FIG. 5 may be regarded as corresponding to a block formed by collecting the OH processing units 212, 232, and 235 of FIG. 4. Further, the H/S interface 502 of FIG. 5 may be regarded as corresponding to a block formed by collecting the H/S interfaces 214, 236, and 237 of FIG. 4. Both of the setting signal lines and the notification signal lines are an example of the control signal line.

The setting signal line delivers, for example, the setting information of the OH processing received from the device control unit to the OH processing unit 501. The notification signal line notifies, for example, the OH monitoring result (may be referred to as “OH status”) in the OH processing unit 501 to the device control unit.

Here, the OH for each port and each layer becomes a target for the setting of OH processing and the notification of OH status. Therefore, in the example of FIG. 4, a set of 91 setting signaling lines and notification signaling lines, that is, OTU2×10 ports)+(ODU0×10 ports×multiplicity 8)+(OTU4×1 port)=91 are arranged between the OH processing unit 501 and the H/S interface 502 of FIG. 5. When the number of ports or the number of layers is increased, the number of wirings is also increased.

As described above, when the number of wirings are simply intended to be connected to the H/S interface in a state of being standardized (may be referred to as a “common H/S interface”), the congestion of signals occurs. When the congestion of signals occurs, the limitation on a physical design may be caused in a case of intending to integrate a circuit in a state of being standardized into an integrated circuit. Further, an example of the integrated circuit may include, for example, an LSI (Large Scale Integration), an FPGA (Field Programmable Gate Array), or an ASIC (Application Specific Integrated Circuit).

Therefore, in the present embodiment, the number of control signals transmitted and received between the OH processing scheduler and the common H/S interface is reduced. Accordingly, the number of lines of the control signals between the OH processing scheduler and the common H/S interface may be reduced to avoid or reduce the congestion of signals.

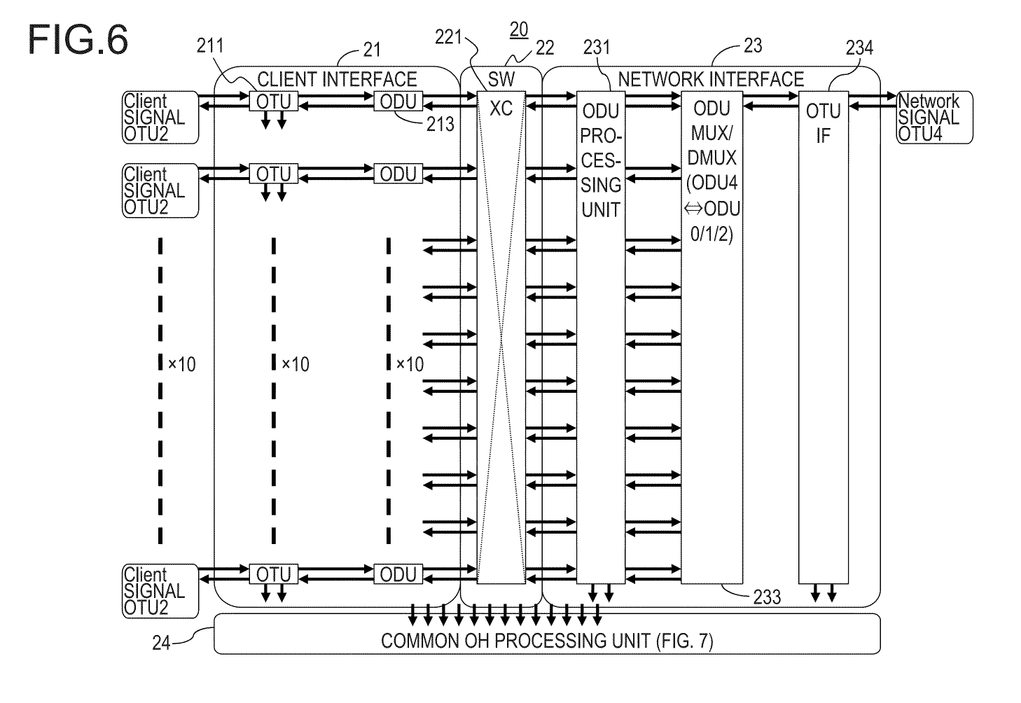

In FIG. 6, an exemplary configuration of the ADM 20 according to an embodiment is illustrated. The configuration of the ADM 20 illustrated in FIG. 6 corresponds to a configuration in which the OH circuits included in the configuration illustrated in FIG. 4 are collected to be commonly shared in the common OH processing unit 24. Therefore, the OH circuits are being removed in the client interface 21 and the network interface 23 illustrated in FIG. 6.

Alternatively, respective OTU interfaces 211 to which respective OH circuits for the OTU signal were connected in the client interface 21 and the common OH processing unit 24 are connected to be communicable with each other. Further, the ODU processing unit 231 and the OTU interface 234 to which the OH circuit for the ODU signal and the OH circuit for the OTU signal connected, respectively, in the network interface 23 and the common OH processing unit 24 are connected to be communicable with each other.

In FIG. 6, the OTU interfaces 211, 234, the ODU processing units 213 and 231, and the ODU MUX/DMUX 233 may be regarded as corresponding to the reception processing unit for the signal transmitted from the client network to the core network. The reception processing unit performs the reception processing on the signal into which signals with different rates having the OH information are hierarchically multiplexed.

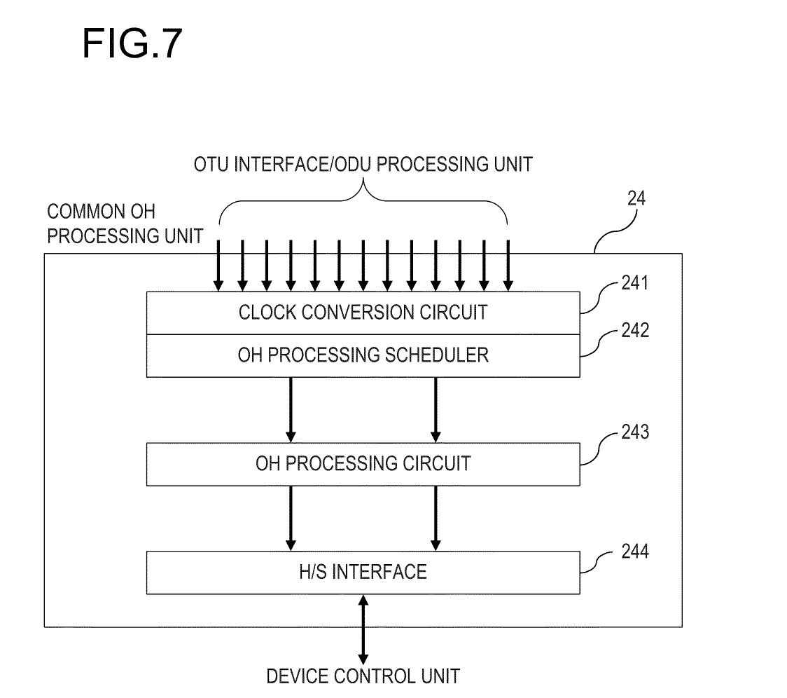

The common OH processing unit 24 includes a clock conversion circuit 241, an OH processing scheduler 242, an OH processing circuit 243, and a common H/S interface 244 as illustrated in FIG. 7.

In a case where other clock source is used in each port or each layer, the clock conversion circuit 241 converts (may be referred to as “replaces”) a signal processing clock into a clock (e.g., a system clock) common to each port and each layer. Accordingly, the OH processing for the signal of each port and each layer may be processed according to the common system clock.

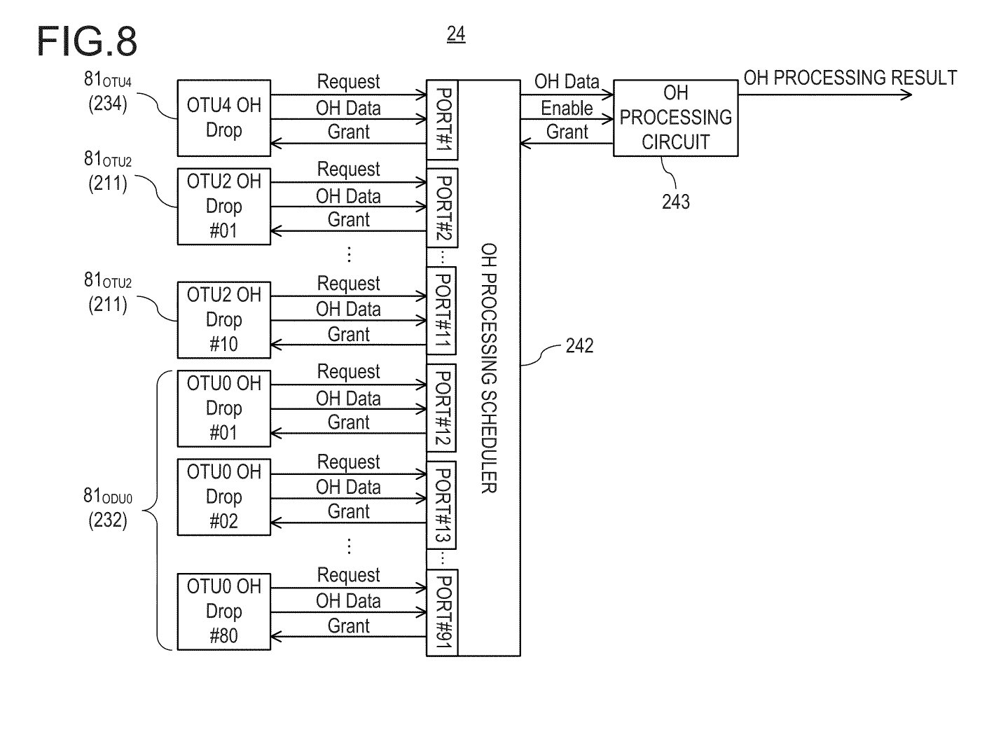

The OH processing scheduler 242 illustratively schedules the OH processing according to a priority determined according to a signal rate of each port and each layer. In FIG. 8, an example of a configuration of the OH processing scheduler 242 is illustrated in a case where 91 signals, that is, (OTU2×10 ports)+(ODU0×10 ports×multiplicity 8)+(OTU4×1 port)=91 (signals), to be subjected to the OH processing are present.

As illustrated in FIG. 8, the OH processing scheduler 242 includes input/output ports #1 to #91 according to the number of signal to be subjected to the OH processing.

An OTU 4-OH drop circuit 81_{OTU4} which separates (drops) an OH of OTU4 signal is connected illustratively to the input/output port #1. The OTU 4-OH drop circuit 81_{OTU4} is provided illustratively in the OTU interface 234 which processes OTU4 signal in the network interface 23.

A total of 10 OTU2-OH drop circuits 81_{ODU0} #01 to #10 each of which drops the OUT signal are connected to 10 input/output ports #2 to #11, respectively. The OTU2-OH drop circuits 81_{ODU0} are illustratively provided in the number of OTU interfaces 211 which amounts to the number of 10 ports and which process the OTU2 signal in the client interface 21, respectively.

A total of 80 ODU0-OH drop circuits 81_{ODU0} #01 to #80 each of which drops the OH of ODU0 signal are connected to the number of input/output ports #12 to #91 amounting to the number of 80 ports, respectively. The ODU0-OH drop circuits 81_{ODU0} are provided in the ODU processing unit 231 that processes 80 ODU0 signals at the maximum in the network interface 23.

When the OH drop circuits 81_{OTU4}, 81_{OTU2}, and 81_{ODU0} do not need to be differentiated, the OH drop circuits are simply denoted by an “OH drop circuit 81.”

The OH drop circuit 81 makes communication for the OH processing through the input/output port #j (j=1 to 91) of the OH processing scheduler 242 to which the OH drop circuit 81 is connected. For example, the OH drop circuit 81 transmits the dropped OH data together with the OH processing request to the OH processing scheduler 242.

When a plurality of OH processing requests are received at the same timing, the OH processing scheduler 242 schedules the OH processing such that the OH data of the signal of a layer having a higher priority is preferentially processed in the OH processing circuit 243. The priority level of the OTU4 is, for example, higher than that of the OTU2 which is higher than that of OTU0, that is, following the order of OTU4>OTU2>ODU0.

Further, the OH processing scheduler 242 manages the layer of input/output port #j connected with the OH drop circuit 81 and may identify the layer for the OH processing request based on a port number of the input/output port #j which has received the OH processing request. When the OH processing requests of the same layer compete with each other, the OH processing request to be preferentially processed may be determined based on the port number of the input/output port #j.

For example, in an example of FIG. 8, the priority may be set in an ascending order of the port number of the input/output port #j. That is, the priority may be set following the order of port #1>port #2> . . . >port #90>port #91. However, in contrary to the example of FIG. 8, the OH drop circuit 81 of a higher layer, of which the extent of level is proportional to a port number, is connected as the port number of the input/output port #j becomes larger, the priority may be set in a descending order of the port number of the input/output port #j.

In other words, when the OH drop circuit 81 of a higher layer (or, a lower layer) is connected to the input/output port #j in an ascending order or descending order of the port number, it becomes easy to identify and manage a layer according to the port number and the priority.

First of all, when a correspondence between the layer of the OH drop circuit 81 connected to the input/output port #j and the port number of the input/output port #j is managed in the OH processing scheduler 242, the layer (priority) may be identified.

The OH processing scheduler 242 sequentially transmits the OH data together with an enable signal for the OH processing to the OH processing circuit 243 according to a scheduling result for the OH processing request.

When the OH data together with the enable signal are received from the OH processing scheduler 242, the OH processing circuit 243 performs a processing (e.g., OH status monitoring) on the received OH data. The processing result of the OH data is notified to the device control unit through, for example, the common H/S interface 244.

When the OH processing is normally ended, the OH processing circuit 243 replies a response (e.g., a grant) indicating that the OH processing is normally ended to the OH processing scheduler 242.

When a grant is received from the OH processing circuit 243, the OH processing scheduler 242 transmits the grant to the corresponding OH drop circuit 81 to notify that the OH processing is normally ended.

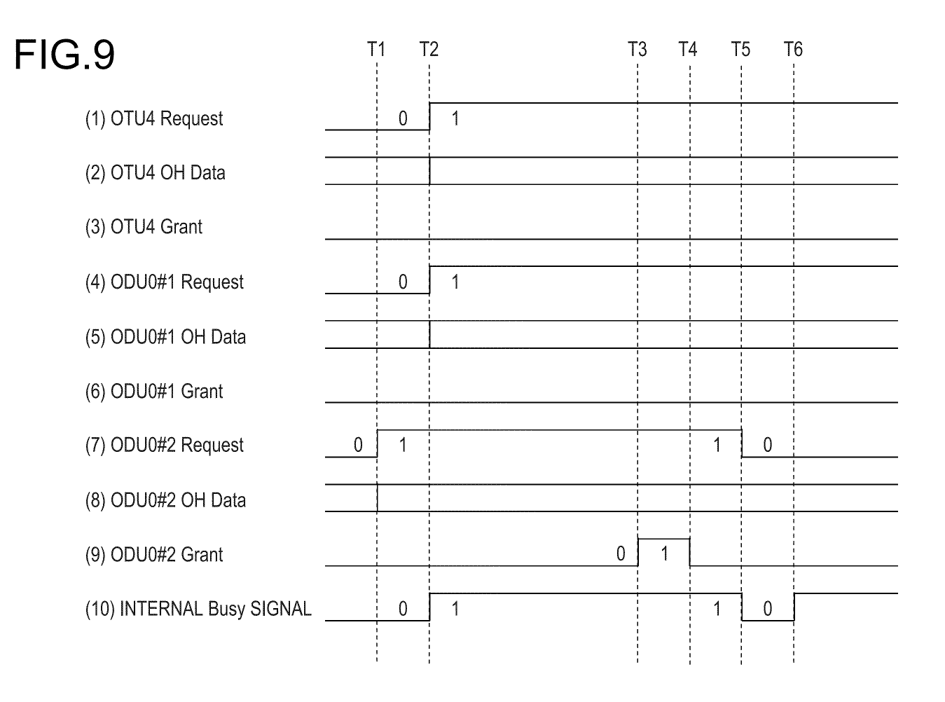

In FIG. 9, an example of operations of the OH processing scheduler 242 (hereinafter, may be abbreviated as the “scheduler 242”) is illustrated. In FIG. 9, a case is illustrated in which the OH processing request for ODU0 signal is received first on a first-come-first served basis and thereafter, the OH processing request for OTU4 signal and the OH processing request for ODU0 signal compete with each other.

In a case where an internal busy signal illustrated at (10) of FIG. 9 is set to “1,” the OH processing scheduler 242 does not receive a new OH processing request.

When the OH processing of any one of the layers is initiated (enabled) in the OH processing circuit 243, the internal busy signal transitions from “0” to “1.” When the OH processing of any one of the layers is normally ended to be in a disable state, the internal busy signal transitions from “1” to “0.” The internal busy signal may be referred to as the “flag information.”

As illustrated at (7) and (8) of FIG. 9, it is assumed that the OH processing request (ODU #2 Request) together with the OH data (ODU0 #2 OH Data) are transmitted from the ODU0-OH drop circuit #02 connected to the input/output port #13 of FIG. 8 to the scheduler 242 at time T1.

Since the internal busy signal illustrated at (10) of FIG. 9 is “0” at time T1, the scheduler 242 receives the OH processing request (ODU #2 Request) and transmits the received OH data (ODU0 #2 OH Data) together with an enable signal to the OH processing circuit 243.

As the OH processing request (ODU #2 Request) for ODU0 signal is received, the scheduler 242 changes the internal busy signal to “1” at, for example, time T2 as illustrated at (10) of FIG. 9.

Here, as illustrated at (1) and (2) of FIG. 9, it is assumed that the OH processing request (ODU4 Request) together with the OH data are transmitted from the OTU 4-0H drop circuit 81_{OTU4} connected to the input/output port #1 of FIG. 8 to the scheduler 242 at time T2.

Further, as illustrated at (4) and (5) of FIG. 9, it is assumed that the OH processing request (ODU0 #1 Request) together with the OH data are transmitted from the ODU0-OH drop circuit #01 connected to the input/output port #12 of FIG. 8 to the scheduler 242 at time T2.

However, since the internal enable signal is set to “1” at time T2, the scheduler 242 does not receive any one of the OH processing request (OTU4 Request, ODU0 #1 Request) for the OTU4 signal or the ODU0 signal.

In the meantime, it is assumed that the processing for the OH data (ODU0 #2 OH Data) for which the OH processing request (ODU #2 Request) is received is normally ended in the OH processing circuit 243 at time T1 and the OH processing circuit 243 has transmitted a grant at a time between time T3 and time T4, as illustrated at (9) of FIG. 9.

When the grant is received, the scheduler 242 transmits the grant to a transmission source ODU0-OH drop circuit #02 of the OH processing request (ODU #2 Request). The ODU0-OH drop circuit #02 disables the OH processing request (ODU #2 Request) according to the grant received from the scheduler 242 at, for example, time T5 as illustrated at (7) of FIG. 9.

When the OH processing request is disabled, the scheduler 242 changes the internal busy signal from “1” to “0” as illustrated at (10) of FIG. 9. After time T5 at which the internal busy signal becomes “0”, the scheduler 242 becomes in a state capable of receiving the OH processing request.

Here, as illustrated at (1) or (4) of FIG. 9, the OH processing requests (OTU4 Request, ODU0 #1 Request) for the OTU4 signal or the ODU0 signal are competitively in the enable state after time T2.

The scheduler 242 receives the OH processing request (OTU4 Request) received from the OTU 4-OH drop circuit 81_{OTU4} and transmits the OH data (OTU4 OH Data) to the OH processing circuit 243 in order to allow the OH processing of OTU4 signal which is the higher layer signal to be preferentially performed.

When the OH processing request (OTU4 Request) for the OTU4 signal is received, the scheduler 242 changes the internal busy signal from “0” to “1” at time T6 as illustrated at (10) of FIG. 9.

Thereafter, when the OH processing for the OTU4 signal is normally ended and a grant is received from the OH processing circuit 234, the scheduler 242 changes the internal busy signal from “1” to “0”. At this timing, when a new OH processing request for the OTU4 signal of a higher layer than that of the ODU signal is not received, the scheduler 242 receives an OH processing request (ODU0 #1 Request) for the lower layer (ODU0 signal) that was not selected at time T5.

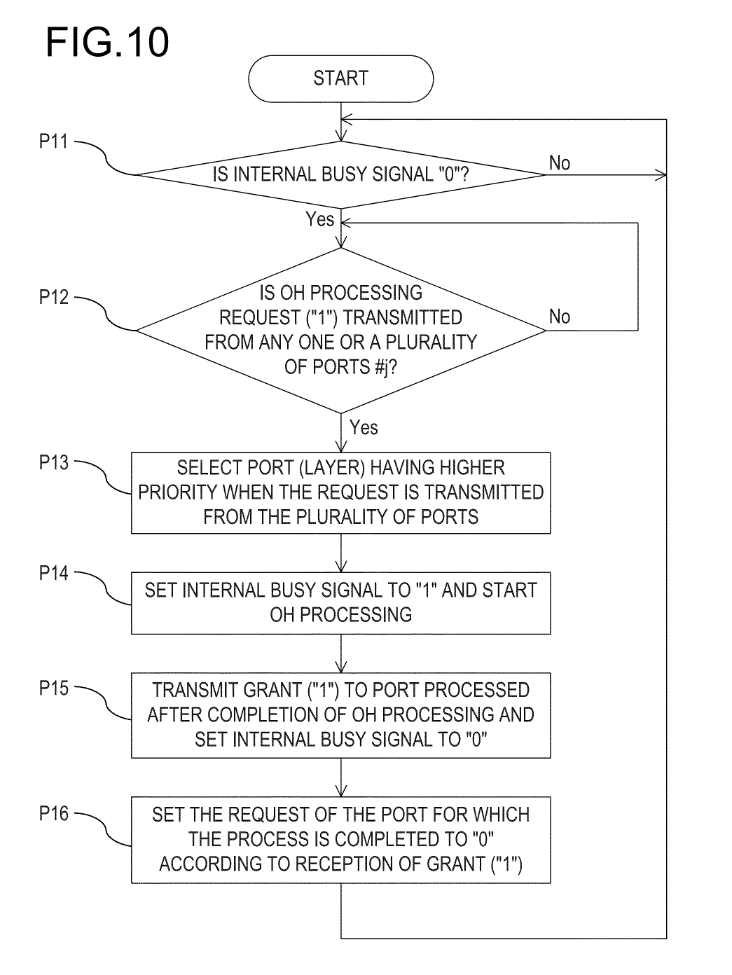

Next, a flowchart of the example of operations of the scheduler 242 described above is illustrated in FIG. 10. As illustrated in FIG. 10, the scheduler 242 checks (may be referred to as “monitoring”) whether the internal busy signal is “0” (Operation P11).

When it is checked that the internal busy signal is “1” (“NO” at Operation P11), the scheduler 242 determines that the OH processing of any one of the layers is already started and does not receive a new OH processing request even when the new OH processing request is received.

In the meantime, when it is checked that the internal busy signal is “0” (“YES” at Operation P11), the scheduler 242 checks whether the OH processing request (“1”) is received at any one or a plurality of the input/output ports #j (Operation P12).

When it is checked that the OH processing request is not received at any one of the input/output ports #j (“NO” at Operation P12), monitoring of the OH processing request is continued.

When it is checked that the OH processing request is received at any one of the input/output ports #j (“YES” at Operation P12) and a plurality of OH processing requests do not compete with each other, the scheduler 242 receives the OH processing request. When it is checked that the plurality of OH processing requests compete with each other, the scheduler 242 receives the OH processing request received at the input/output port #j having a higher priority (Operation P13).

When the reception of the OH processing request is received, the scheduler 242 sets the internal busy signal to “1” and transmits the OH data together with an enable signal to the OH processing circuit 243 to start the OH processing (Operation P14).

Thereafter, when the OH processing by the OH processing circuit 243 is normally ended and a grant is received from the OH processing circuit 243, the scheduler 242 issues a grant set to “1” from the input/output port #j which has received the OH processing request to the OH drop circuit 81. Further, the scheduler 242 sets the internal busy signal to “0” (Operation P15).

When the grant (“1”) is received from the scheduler 242, the OH drop circuit 81 sets the OH processing request to “0” (disable) (Operation P16).

As described above, the scheduler 242 schedules the OH processing requests received through the respective input/output ports #j such that the OH processing of the higher layer is preferentially performed. Accordingly, even though communization of the OH processing circuit 243 has been allowed, it becomes possible to complete the OH processing for the signals of the lower layer within, for example, 1 frame period of the higher layer signal. Accordingly, a failure of the OH processing accompanied by the standardization may be avoided.

Further, the maximum allowable capability for the common OH processing by the scheduler 242 is determined according to a rate (in other words, 1 frame time) of the highest layer signal regarded as a processing target by the ADM 20. As a non-limiting example, it is assumed that an operation clock (system clock) of the OH processing is 170 [MHz] and it takes a time amounting to 7 clocks for the OH processing in the OH processing circuit 243. That is, it is assumed that it takes a processing time amounting to approximately 41.176 [ns], which is obtained by (1/170 [MHz])×7 [clocks]×1000≈41.176 [ns], for the OH processing in the OH processing circuit 243.

In the current ITU-TG. 709 Standard, the OTU4 signal is the highest layer signal, that is, signal having the highest rate and the frame time is 1.168 [ρs], that is, 1168 [ns], as illustrated in Table 1. Further, the ITU-T is an abbreviation of “International Telecommunication Union Telecommunication Standardization Sector.”

Accordingly, the number of OH processing capable of being processed within 1 frame time of the OTU4 signal is 1176 [ns]÷41.176 [ns]≈28.3. That is, the OH processing for 28 OTU4 signal at the maximum may be processed by the scheduler 242 and the OH processing circuit 243.

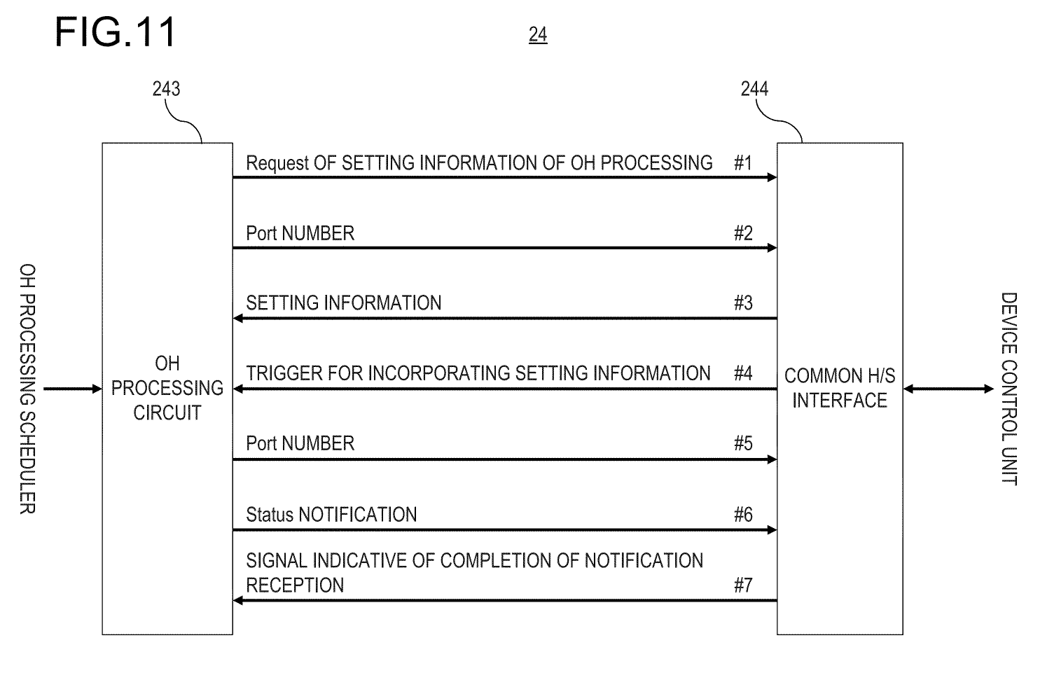

Next, descriptions will be made on an example of a control communication and a connection between the OH processing circuit 243 and the common H/S interface 244 illustrated in FIG. 7 with reference to FIG. 11 to FIG. 13.

As illustrated in FIG. 11, the OH processing circuit 243 and the common H/S interface 244 are connected with each other through, for example, 7 types of signal lines #1 to #7. Further, in the following, the “common H/S interface 244” may be referred to as the “common interface 244.”

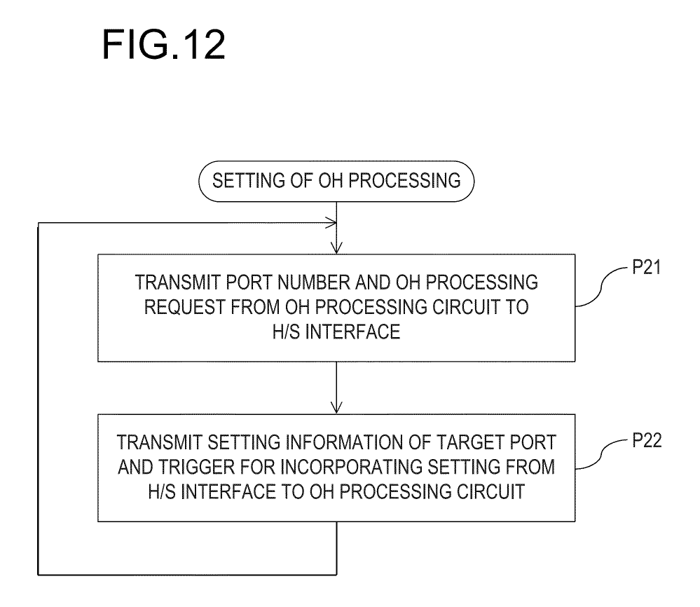

The OH processing circuit 243 requests the device control unit described above, through the first signal line #1, to transmit the setting information of the OH processing (may be referred to as “OH setting request”). In addition, the OH processing circuit 243 transmits the port number for which the OH setting request is made to the common H/S interface 244 through the second signal line #2 in order to make the device control unit possible to identify the request regarding which port number that corresponds to the OH setting request (Operation P21 of FIG. 12).

Further, “the port number” corresponds to, for example, the input/output port number #j of the scheduler 242 illustrated in FIG. 8. Accordingly, the port number #j may be regarded as corresponding to an example of the information identifying a layer of the signal to be subjected to the OH processing as described above.

The common interface 244 transmits a set of the OH setting request and the port number #j received through the first signal line #1 and the second signal line #2, respectively, to the device control unit.

When the set of the OH setting request and the port number #j are received from the common interface 244, the device control unit identifies that the OH setting request is for the port number #j and transmits the setting information of the OH processing for the identified port number #j to the common interface 244.

The common interface 244 provides the setting information received from the device control unit to the OH processing circuit 243 through the third signal line #3. In this case, the common interface 244 may provide a trigger signal for incorporating the setting information (in other words, reflecting the settings) into the OH processing circuit 243 to the OH processing circuit 243 through the fourth signal line #4 (Operation P22 of FIG. 12).

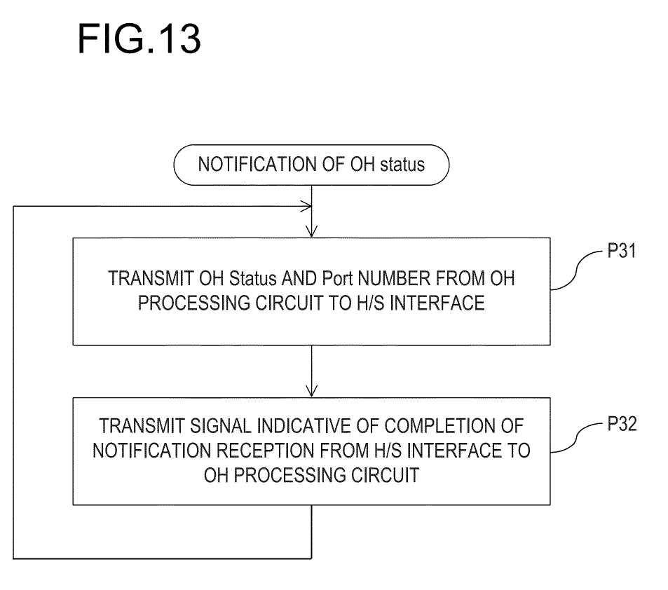

The OH processing circuit 243 which has received the setting information performs the OH processing (illustratively, monitoring) of the target port number #j (layer) according to the setting information and notifies the processing result (illustratively, OH status) to the common interface 244 through the sixth signal line #6. In addition, the OH processing circuit 243 transmits the port number #j to the common interface 244 through the fifth signal line #5 in order to indicate the result regarding which OH processing that corresponds to the OH status (Operation P31 of FIG. 13).

The common interface 244 transmits a set of the OH setting request and the port number #j received through the fifth signal line #5 and the sixth signal line #6, respectively, to the device control unit. When the set of the port number #j and the OH status is received, the common interface 244 may transmit a signal indicating that the reception of notification is completed to the OH processing circuit 243 through the seventh signal line #7 (Operation P32 of FIG. 13).

When the set of the port number #j and the OH status is received from the common interface 244, the device control unit performs the OH processing according to the OH status about the port number #j.

The first to the seventh signal lines #1 to #7 described above are examples of the control signal lines used for the control communication (or control access) between the OH processing circuit 24 and the device control unit.

Here, the setting information or the OH status for the OH processing described above does not need to be transmitted and received per a system clock and may be transmitted and received at the timing for OH processing scheduled by the scheduler 242.

In other words, the control communication including the settings of the OH processing for the OH processing circuit 243 or the notification of the OH status for the device control unit is also scheduled according to the scheduling of the OH processing. Accordingly, it does not need to separately arrange the control signal line for each rate (layer) of the signal or each port of the ADM 20 and the congestion of signals may be avoided when standardization of the H/S interface 244 is allowed.

As having been described above, according to the embodiment described above, since the OH processing is scheduled according to the rate (or layer) of signal by the scheduler 242, the OH processing for the signals having different rates may be processed in the common OH processing circuit 243.

Accordingly, as illustrated in FIG. 2 to FIG. 4, the OH circuits do not need to be separately provided at other ports and other layers and the hardware resources consumption (in other words, scale) for the OH processing may be reduced. Further, the power consumption may be reduced as the hardware scale is reduced.

For example, standardization of the OH circuits provided at 91 locations in the example of FIG. 4 may be allowed to be collected at one location of the common OH processing unit 24 (OH processing circuit 243) in the examples of FIG. 6 and FIG. 7. Accordingly, even when an addition of the processing scheduler 242 is taken into account, an effect that hardware scale and power consumption are reduced by approximately 50% may be anticipated.

Further, even though the number of layers (types) is increased due to the increase of the capacity of the target signal to be processed by the ADM 20, the OH processing for the respective layers may be processed in common in the OH processing circuit 243 without depending on the number of layers. Accordingly, it is possible to easily and flexibly cope with the increase of the capacity of the target signal to be processed by the ADM 20.

Also, when the OH processings of the different layers compete with each other, the scheduler 242 may preferentially schedule the OH processing for the higher layer signal (in other words, signal having more higher signal rate) than the lower layer signal to an extent of which is proportional to a level difference between the lower layer signal and the higher layer. Accordingly, a failure of the OH processing accompanied by the standardization may be avoided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a reception processing unit configured to perform a reception processing on a first signal into which second signals having different rates and including overhead information are hierarchically multiplexed; and
a common overhead processing unit configured to process the overhead information included in the first and second signals according to a common rate to hierarchical layers.

2. The transmission apparatus according to claim 1,
wherein the common overhead processing unit is configured to include:
an overhead processing circuit configured to process the overhead information, and
a scheduler configured to perform scheduling, according to the different rates, on the overhead information to be processed by the overhead processing circuit.

3. The transmission apparatus according to claim 2,
wherein the scheduler is configured to perform the scheduling such that the overhead information of the signal having a higher rate is preferentially processed over the signal having a lower rate.

4. The transmission apparatus according to claim 2,
wherein the common overhead processing unit is configured to include an interface that performs scheduling on a control communication between the overhead processing circuit and a device control unit of the transmission apparatus according to the scheduling by the scheduler.
